(19) United States
(12) Patent Application Publication
(10) Pub. No.: US 2006/0224489 A1
(43) Pub. Date: Oct. 5, 2006

(54) Method and system for providing displays of securities trading information

(76) Inventors: Thomas L. Pantelis, Palatine, IL (US); Panding Zhu, Chicago, IL (US)

Correspondence Address: BEEM PATENT LAW FIRM, 53 W. JACKSON BLVD., SUITE 1352, CHICAGO, IL, 60604-3787, US

(21) Appl. No.: 11/093,932

(22) Filed: Mar. 30, 2005

(51) Int. Cl. G06Q 40/00

(52) U.S. Cl. 705/37

(57) ABSTRACT

A method for providing a display of securities information, said includes entering securities trading information comprising a closing price for at least one security from a previous trading period, at least one price for the at least one security in a current trading period, and displaying the securities-trading information in the form of at least one circular clock-like display.

### BACKGROUND OF THE INVENTION

The present invention is directed to a method and system for providing displays of securities trading information.

2. Description of the Related Art

Although several methods exist to display prices and other information relating to the trading history of a security, some methods provide displays with only very limited capabilities. One example of this type of displays is a display of only the daily trading ranges and the closing prices. A second example is a time-line graph of the price of a security. Displays of this type, though of interest, would not be able to provide much important information to the trader. Without more specifics and an easy to read and easy to use display system, the financial information is incomplete and of limited use to the trader.

### BRIEF SUMMARY OF THE INVENTION

A novel method and system for providing displays of securities trading information comprises entering securities trading information, said securities trading information comprising a desired reference point, and at least one price for at least one security in a current trading period, and displaying said securities-trading information in the form of at least one circular clock-like display.

These and other features and advantages are evident from the following description of the present invention, with reference to the accompanying drawings.

### BRIEF DESCRIPTION OF THE SEVERAL VIEWS OF THE DRAWINGS

FIG. 1 is a view of a first display in accordance with one embodiment of the invention;

FIG. 2 is a view of a data entry screen for creating a desired display in accordance with one embodiment of the invention;

FIG. 3 is a diagram of a method for creating displays in accordance with one embodiment of the invention;

FIG. 4 is a view of another display in accordance with one embodiment of the invention;

FIG. 5 is a view of another display in accordance with one embodiment of the invention;

FIG. 6 is a view of another display in accordance with one embodiment of the invention;

FIG. 7 is a view of another display in accordance with one embodiment of the invention;

FIG. 8 is a view of another display in accordance with one embodiment of the invention;

FIG. 9 is a view of another display in accordance with one embodiment of the invention;

FIG. 10 is a view of another display in accordance with one embodiment of the invention;

FIG. 11 is a view of another display in accordance with one embodiment of the invention;

FIG. 12 is a view of another display in accordance with one embodiment of the invention;

FIG. 13 is a view of another display in accordance with one embodiment of the invention;

FIG. 14 is a view of another display in accordance with one embodiment of the invention; and

FIG. 15 is a view of another display in accordance with one embodiment of the invention.

### DETAILED DESCRIPTION OF THE INVENTION

This invention provides, at a glance, simple and yet comprehensive displays of the trading information without the need for going through pages of data and making comparative evaluations either mentally or assisted by other means. The displays can be dynamic, i.e., to reflect the instantaneous trading data. If desired, the display could indicate desired limits, such as high and low prices for a time period of interest. Alternatively, market dynamics based on additional relevant data such the high, low, close, last trade, and the volatility at certain trading prices could also be accessed from a single display screen in a format that is easy to understand. If reversals or accelerations took place during the trading day, dynamic displays can be used to connect such occurrences with specific events, trades, e.g., either an anticipated or a surprise action taken by the Federal Reserve Board.

Initially and for our discussions we will be focusing on futures prices, and their relationship to similar and derivative contracts, such as options. We have initially focused on the 10 year futures contract based on the current deliverable U.S. Government Treasury note (TY), as it is the most active contract at the Chicago Board of Trade (CBOT). The invention is useful not only for these contracts but also other financial and non-financial futures and option contracts, as well as equity products. The invention also has valuable educational applications, in terms of helping students understand derivatives.

Because of the arcane nature of futures prices, and therefore their relationship to similar and derivative contracts, the displays or “clocks” of the invention, w/the sophisticated software of the invention, make complex relationships easily discernable rather quickly.

Symbols used include but are not limited to the following:
US—Futures contract based on the current deliverable U.S. Government Treasury bond (a security w/a life of 15 or more years). Currently there are quite a few bonds available for delivery against the futures contract. The contract specifications (See tables below on the Chicago Board of Trade (CBOT) web page (www.cbot.com)) specify among other things, trading times delivery terms, tic value, pricing and so forth.
TY—Futures contract based on the current deliverable U.S. Government Treasury note. (a note is defined as having a life of at least 2 years and less than 15).
FV—Futures contract based on the current deliverable U.S. Government Treasury note with a 5 yr life.
TU—Futures contract . . . 2 yr. life.
FF—Futures contract . . . overnight Fed Funds rate. This is the rate the Federal Reserve controls directly and applies to overnight bank loans.

These are the symbols for the Main futures contracts traded in the financial room at the Chicago Board of Trade (CBOT).

The financial futures contracts are similar in that the trade on a quarterly basis symbolized as follows.
H—March
M—June
U—Sep.
Z—Dec.

Other calendar month symbols that are applicable to the option contracts that are related to the above futures months are
F—Jan.
G—Feb.
H—March
J—April
K—May
M—June
N—July
Q—Aug.
U—Sep.
V—Oct.
X—Nov.
Z—Dec.

Options consist of Puts and Calls and are exercisable at the owner's discretion, against the futures contracts. The contract specifications for these are also on the CBOT web site.

The volatility is defined as follows: The annualized standard deviation (variance from the mean) between the bond (or other security) price now, and 1 year from now. So if volatility is running @ 5% on a given options there is a 66% certainty that the price will be w/in a 5% range of where it is today 1 year from now. Historical volatility, tells you what the market expects based on the closing prices over the last 30 days, and is a mathematical certainty. Implied volatility reflects whether or not the market believes the historical rate is correctly predicting future events. If implied is lower than historical this would mean futures events (economic indicators, socioeconomic events and what have you) look dull. If implied is greater, then future events could be volatile.

Since the options are priced differently, the clocks have to be calibrated as such. The volatility associated w/each option is of the implied variety, as opposed to historical. Implied volatility is derived by taking the current prices that an options trades at, at that moment.

A volatility display or “clock” associated with each option will be updated each time that the floor broker inputs an actual trade. This is important because the exchanges do not report this information. It is there, but it is up to each member to decide what inputs to use when trying to figure out volatility. The system of the invention will do this, when the floor broker inputs the correct data, namely the option that traded and its price, the futures contract that it is related to and the associated prices at the correct time.

This way of updating volatility, is not unique, floor traders have to do it to remain competitive, professional traders rely on various information sources. Most of this information is related via voice and electronically via e-mail, news services and web pages. In this regard, the invention is unique in that a large amounts of data can be viewed instantly in a relatively simple graph form

10 Year U.S. Treasury Notes Futures

Contract Size
One U.S. Treasury note having a face value at maturity of $100,000
or multiple thereof.
Deliverable Grades
U.S. Treasury notes maturing at least 6½ years, but not more than
10 years, from the first day of the delivery month. The invoice price
equals the futures settlement price times a conversion factor plus
accrued interest. The conversion factor is the price of the delivered
note ($1 par value) to yield 6 percent.
Tick Size
Minimum price fluctuations shall be in multiples of one-half of one thirty-
second ( 1/32) point per 100 points ($15.625 rounded up to the nearest cent
per contract) except for intermonth spreads, where minimum price
fluctuations shall be in multiples of one-fourth of one thirty-second point
per 100 points ($7.8125 per contract). Par shall be on the basis of 100
points. Contracts shall not be made on any other price basis.
Price Quote
Points ($1,000) and one half of 1/32 of a point; i.e., 84-16 equals
84 16/32, 84-165 equals 84 16.5/32
Contract Months
Mar, Jun, Sep, Dec
Last Trading Day
Seventh business day preceding the last business day of the delivery
month.
Last Delivery Day
Last business day of the delivery month.
Delivery Method
Federal Reserve book-entry wire-transfer system
Trading Hours
Open Auction: 7:20 am-2:00 pm, Central Time, Monday-Friday
Electronic: 7:00 pm-4:00 pm, Central Time, Sunday-Friday
Trading in expiring contracts closes at noon, Chicago time, on the last
trading day.
Ticker Symbols
Open Auction: TY
Electronic: ZN
Daily Price Limit
None
Margin Information
Find information on margins requirements for the 10 Year U.S. Treasury
Notes Futures.

10 Year Treasury Note Options

Contract Size
One CBOT 10-Year U.S. Treasury Note futures contract (of a
specified delivery month) having a face value at maturity of $100,000
or multiple thereof.
Expiration
Unexercised 10 Year Treasury Note futures options shall expire at
7:00 p.m. Central Time on the last day of trading.
Tick Size
1/64 of a point ($15.625/contract) rounded up to the nearest cent/contract.
Contract Months
The first three consecutive contract months (two serial expirations and one
quarterly expiration) plus the next two months in the quarterly cycle (Mar,
Jun, Sep, Dec). There will always be five months available for trading.
Monthlies will exercise into the first nearby quarterly futures contract.
Quarterlies will exercise into futures contracts of the same delivery period.
Last Trading Day
Options cease trading in the month prior to the delivery month of the
underlying futures contract. Options cease trading at the same time as the
underlying futures contract on the last Friday preceding by at least two
business days the last business day of the month preceding the option
contract month.
Trading Hours
Open Auction: 7:20 am-2:00 pm, Central Time, Monday-Friday
Electronic: 7:02 pm-4:00 pm, Central Time, Sunday-Friday
Trading in expiring contracts closes at the same time as the underlying
futures contract (2:00 pm, Central Time) on the last trading day
Ticker Symbols
Open Auction: TC for calls, TP for puts
Electronic: OZN
Daily Price Limit
None
Strike Price Intervals
1 point ($1,000/contract) to bracket the current T-note futures price. If 10-
year T-note futures are at 92-00, strike prices may be set at 89, 90, 91, 92,
93, 94, 95, etc.
Exercise
The buyer of a futures option may exercise the option on any business day
prior to expiration by giving notice to the Board of Trade clearing service
provider by 6:00 pm, Central Time. Options that expire in-the-money are
automatically exercised into a position, unless specific instructions are
given to the Board of Trade clearing service provider.
Margin Information
Find information on margins requirements for the 10 Year Treasury Note
Options.

5 Year U.S. Treasury Notes Futures

Contract Size
One U.S. Treasury note having a face value at maturity of $100,000
or multiple thereof.
Deliverable Grades
U.S. Treasury notes that have an original maturity of not more than 5
years and 3 months and a remaining maturity of not less than 4 years
and 2 months as of the first day of the delivery month. The 5-year
Treasury note issued after the last trading day of the contract month will
not be eligible for delivery into that month's contract. The invoice price
equals the futures settlement price times a conversion factor plus
accrued interest. The conversion factor is the price of the delivered
note ($1 par value) to yield 6 percent.
Tick Size
Minimum price fluctuations shall be in multiples of one-half of one thirty-
second ( 1/32) point per 100 points ($15.625 rounded up to the nearest cent
per contract) except for intermonth spreads, where minimum price
fluctuations shall be in multiples of one-fourth of one thirty-second point
per 100 points ($7.8125 per contract). Par shall be on the basis of 100
points. Contracts shall not be made on any other price basis.
Price Quote
Points ($1,000) and one half of 1/32 of a point; i.e., 84-16 equals
84 16/32, 84-165 equals 84 16.5/32
Contract Months
Mar, Jun, Sep, Dec
Last Trading Day
Seventh business day preceding the last business day of the delivery month
Last Delivery Day
Last business day of the delivery month
Delivery Method
Federal Reserve book-entry wire-transfer system
Trading Hours
Open Auction: 7:20 am-2:00 pm, Central Standard Time, Monday-Friday
Electronic: 7:00 pm-4:00 pm, Central Standard Time, Sunday-Friday
Trading in expiring contracts closes at noon, Central Standard Time, on
the last trading day
Ticker Symbols
Open Auction: FV
Electronic: ZF
Daily Price Limit
None
Margin Information
Find information on margins requirements for the 5 Year U.S. Treasury
Notes Futures.

5 Year Treasury Note Options

Contract Size
One CBOT 5-Year U.S. Treasury Note futures contract (of a specified
delivery month) having a face value at maturity of $100,000 or
multiple thereof.
Expiration
Unexercised 5 Year Treasury Note futures options shall expire at
7:00 p.m. Central Time on the last day of trading.
Tick Size
1/64 of a point ($15.625/contract) rounded up to the nearest cent/contract
Contract Months
The first three consecutive contract months (two serial expirations and one
quarterly expiration) plus the next two months in the quarterly cycle (Mar,
Jun, Sep, Dec). There will always be five months available for trading.
Monthlies will exercise into the first nearby quarterly futures contract.
Quarterlies will exercise into futures contracts of the same delivery period.
Last Trading Day
Options cease trading in the month prior to the delivery month of the
underlying futures contract. Options cease trading at the same time as the
underlying futures contract on the last Friday preceding by at least two
business days the last business day of the month preceding the option
contract month.
Trading Hours
Open Auction: 7:20 am-2:00 pm, Central Time, Monday-Friday.
Electronic: 7:02 pm-4:00 pm, Central Time, Sunday-Friday
Trading in expiring contracts closes at the same time as the underlying
futures contract (2:00 pm, Central Time) on the last trading day.
Ticker Symbols
Open Auction: FL for calls, FP for puts
Electronic: OZF
Daily Price Limit
None
Strike Price Intervals
One-half point ($500/contract) to bracket the current T-note futures
price. For example, if 5-year T-note futures are at 94-00, strike prices
may be set at 92.5, 93, 93.5, 94, 94.5, 95, 95.5, etc.
Exercise
The buyer of a futures option may exercise the option on any business day
prior to expiration by giving notice to the Board of Trade clearing service
provider by 6:00 pm, Central Time. Options that expire in-the-money are
automatically exercised into a position, unless specific instructions are
given to the Board of Trade clearing service provider.
Margin Information
Find information on margins requirements for the 5 Year Treasury Note
Options.

2 Year U.S. Treasury Notes Futures

Contract Size
U.S. Treasury notes having a face value at maturity of $200,000 or
multiple thereof.
Deliverable Grades
U.S. Treasury notes that have an original maturity of not more than 5
years and 3 months and a remaining maturity of not less than 1 year
and 9 months from the first day of the delivery month but not more than
2 years from the last day of the delivery month. The invoice price
equals the futures settlement price times a conversion factor plus
accrued interest. The conversion factor is the price of the delivered
note ($1 par value) to yield 6 percent.
Tick Size
Minimum price fluctuations shall be in multiples of one-quarter of one
thirty-second ( 1/32) point per 100 points ($15.625 rounded up to the
nearest cent per contract). Par shall be on the basis of 100 points.
Contracts shall not be made on any other price basis.
Price Quote
Points ($2,000) and one quarter of 1/32 of a point; for example, 91-16
equals 91 16/32, 91-162 equals 91 16.25/32, 91-165 equals 91 16.5/32,
and 91-167 equals 91 16.75/32
Contract Months
Mar, Jun, Sep, Dec
Last Trading Day
The last business day of the calendar month.
Last Delivery Day
Third business day following the last trading day
Delivery Method
Federal Reserve book-entry wire-transfer system
Trading Hours
Open Auction: 7:20 am-2:00 pm, Central Time, Monday-Friday
Electronic: 7:01 pm-4:00 pm, Central Time, Sunday-Friday
Trading in expiring contracts closes at noon, Central Time, on the last
trading day
Ticker Symbols
Open Auction: TU
Electronic: ZT
Daily Price Limit
None
Margin Information
Find information on margins requirements for the 2 Year U.S. Treasury
Notes Futures.

2 Year Treasury Note Options

Contract Size
One CBOT 2-Year U.S. Treasury Note futures contract (of a specified
delivery month) having a face value at maturity of $200,000 or multiple
thereof.
Expiration
Unexercised 2 Year Treasury Note futures options shall expire at
7:00 p.m. Central Time on the last day of trading.
Tick Size
½ of 1/64 of a point ($15.625/contract) rounded up to the nearest
cent/contract.
Contract Months
The first three consecutive contract months (two serial expirations and one
quarterly expiration) plus the next two months in the quarterly cycle (Mar,
Jun, Sep, Dec). There will always be five months available for trading.
Monthlies will exercise into the first nearby quarterly futures contract.
Quarterlies will exercise into futures contracts of the same delivery period.
Last Trading Day
Options cease trading in the month prior to the delivery month of the
underlying futures contract. Options cease trading at the same time as the
underlying futures contract on the last Friday preceding by at least two
business days the last business day of the month preceding the option
contract month.
Trading Hours
Open Auction: 7:20 am-2:00 pm, Central Time, Monday-Friday.
Electronic: 7:02 pm-4:00 pm, Central Time, Sunday-Friday
Trading in expiring contracts closes at the same time as the underlying
futures contract (2:00 pm, Central Time) on the last trading day.
Ticker Symbols
Open Auction: TUC for calls, TUP for puts
Electronic: OZT
Daily Price Limit
None
Strike Price Intervals
One-quarter point ($500/contract) to bracket the current T-note futures
price. For example, if 2-year T-note futures are at 94-00, strike prices
may be set at 93.25, 93.50, 93.75, 94.00, 94.25, 94.50, 94.75, etc.
Exercise
The buyer of a futures option may exercise the option on any business day
prior to expiration by giving notice to the Board of Trade clearing service
provider by 6:00 pm, Central Time. Options that expire in-the-money are
automatically exercised into a position, unless specific instructions are
given to the Board of Trade clearing service provider.
Margin Information
Find information on margins requirements for the 2 Year Treasury Note
Options.

### EXAMPLES

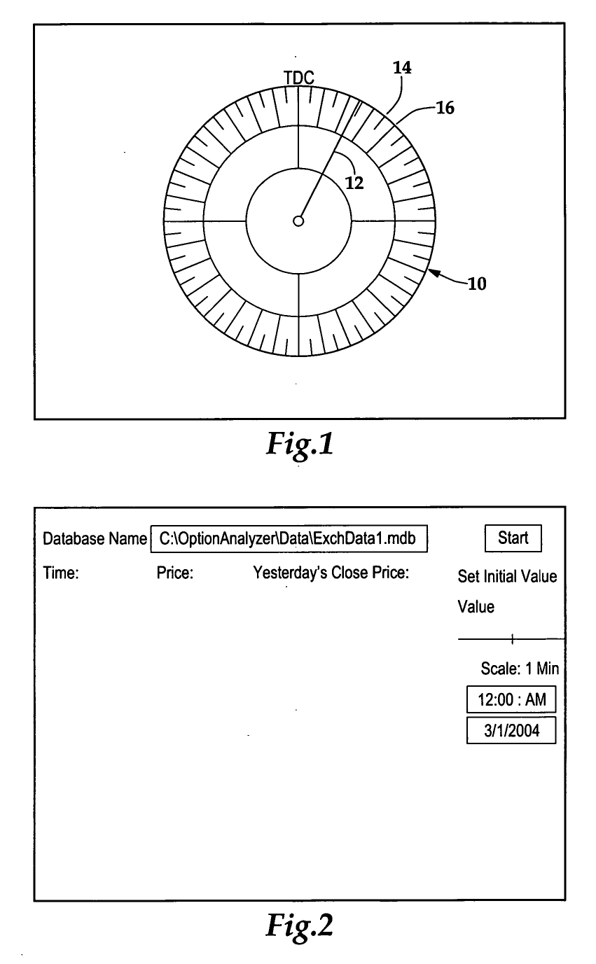

The 10 yr. notes are priced, in points and ½ of 32^{nd}'s of a point or 64ths, hence the display (e.g., in FIG. 1) is calibrated in 64^{th}, using hash marks 14 and 16. Bonds by contrast trade in points and 32^{nd}'s of a point therefore a bond clock would only have to be calibrated in 32^{nd}'s (indicated by the longer hash marks or divisions 16 in FIG. 1).

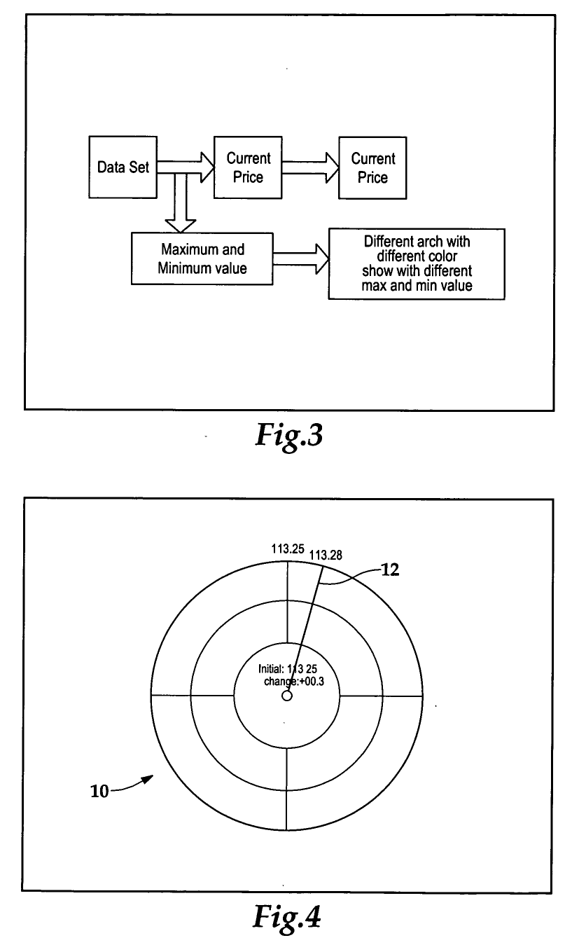

FIGS. 1 shows a basic “clock” display 10, while FIGS. 2 and 3 show how such a display (e.g., FIG. 4) is created from information entered on a basic input screen (FIG. 2) using the basic process shown in FIG. 3, in accordance with one embodiment of the invention. Alternatively, at least some of the information for creating the display may be entered via a live feed from an exchange or other service.

In FIGS. 1 and 4-10, the display or “clock” 10 shows the change from the previous days settlement price, rather that the actual price. In FIGS. 4-10, the top number is the previous day's settlement price (113.25 in the illustrated example). In FIG. 4, the most recent trade is 113.28 which is up 0.03 from settlement, and the clock hand 12 is indicating this by moving clockwise 3 tics. Note that the number after the decimal is the number of 64ths (or other trading increment, e.g., 32nds), while the number ahead of the decimal is a whole number.

The displays shown in FIGS. 1 and 4-15 are created using standard programming languages, such as Visual Basic (VB). First some notes on the programming language used and the concept of controls:

Window controls are based on the control class, and they inherit many properties, methods, and events from it. VB developed many standard controls and most of them are shown on the VB toolbox. Since most controls share many of the same properties, methods and events, the standard controls save much time for developers. Developers just can use the controls directly by double clicking that icon, changing or adding special properties, methods and events which they want. This is why we chose VB to develop this project, it allowed us to write as special code little as possible. But developers have to develop their own controls when standard controls don't provide the desired kind of function.

For example, in our project, we not only use some standard controls, but also developed our own controls to create and operate the “circle with a clock hand or dial” (basically making numeric input show a number on a clock-like display). Like standard controls, our own controls also have properties, methods, and events, we have to create and define the necessary variables and functions to be used in the program. By building kinds of logistical relationships between the properties, methods, and events, our own controls can communicate with standard controls and work like standard controls.

The next step in the program is to define the functions necessary to calibrate the clock. Because of the arcane nature of futures and option contracts, (they are priced in 32nds, and 64ths, of $1,000.00 for financial contracts) this had to be reconciled with the needs of the program in order for the clock to function correctly.

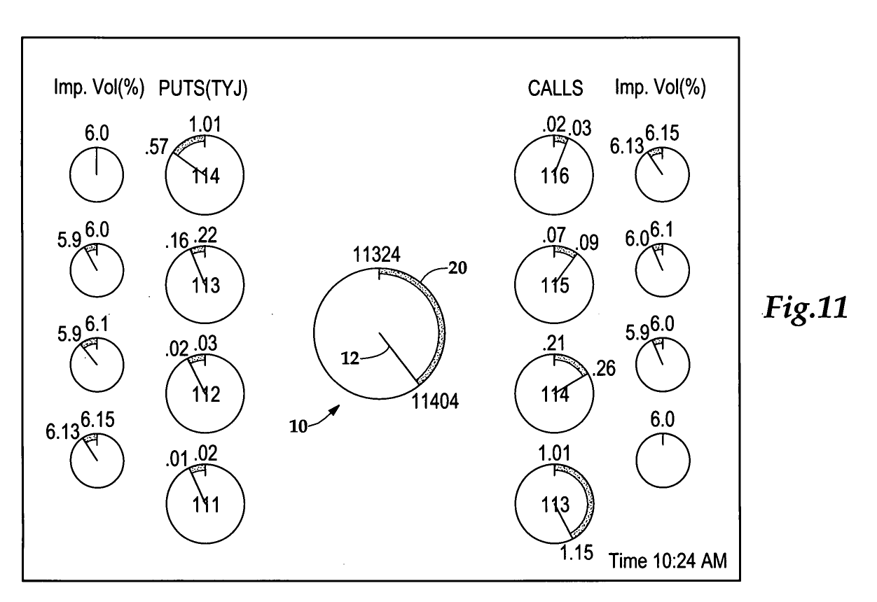

Once the geometry involved in getting a computer screen to make a circle, further programming was created to define the top dead center (TDC) value (12:00 position) Given the needs of the ultimate user, this value, which typically is the previous day's settlement, must also be flexible in that the user can change this value to suit his particular need. This concept is also key in that the program will be receiving vast amounts of input during each trading day and this data when represented as a change from the TDC value will give the user instant and clear values that will quickly discernable. Positioning these clocks alongside derivative clocks (see FIGS. 11-13) will provide much faster understanding of dynamic data flows.

Another concept that required further creative programming, was the addition of colors to differentiate the change (whether positive or negative) from the TDC value, and building concentric radii. This required programming circles within the main circle so that in cases where the trading price range in any given session exceeds one full revolution, (be it 32/32nds, or 64/64ths, or whatever) the user can easily see the entire range, and current value, at a glance. Note all this data is in one “clock” as opposed to linear charts, which require more space. Linear charts also do not employ the TDC concept that shows price relationships much more clearly and quickly. Again the use of colors adds to the concept here and requires precise programming to capture the essence of these concepts.

The clock will be of sufficient size to show this information. In addition, the clock will show the point changes in a similar manner. Referring again to FIG. 4, since the market in this example settled at 113.25, the initial point clock will have 113.25 as the initial 12:00 position or (Top Dead Center, TDC). Top Dead Center (TDC) is always at 12:00 position. In the case of the 10 year note futures clock, there will be a total of 64 divisions 14,16, 32 of which (14) will be shorter in length, to denote ½ ticks, as shown in FIG. 1. The divisions have not been shown in the other Figures, but will be understood to be present in the actual displays. As noted above FIG. 4 shows a current trade at 113.28, or 0.03 above the previous day's settlement of 113.25.

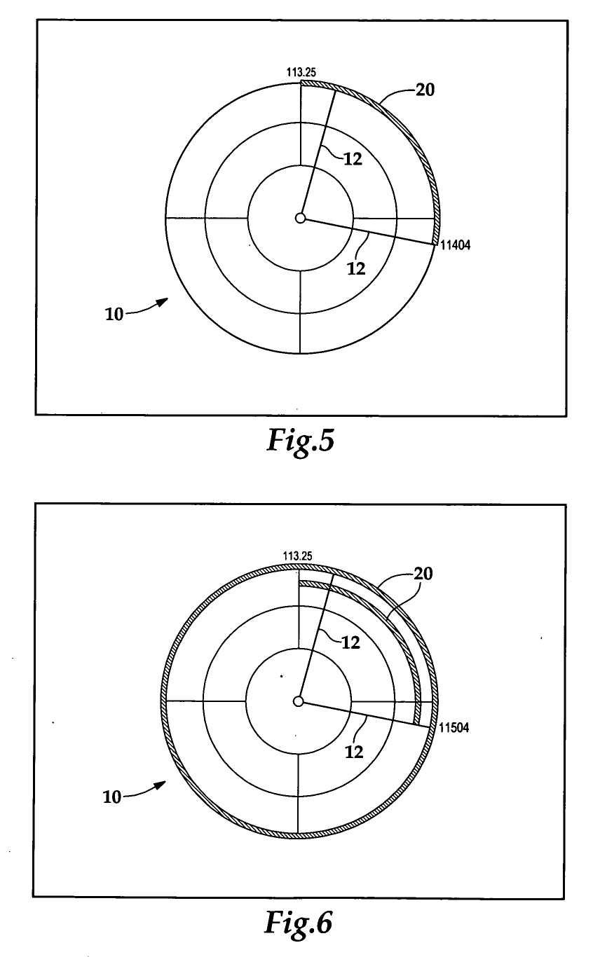

Referring to FIG. 5, when positive maximum change is less than one full revolution, or one full point (32/32nds), a green arch 20 changes with the change of the maximum value and you also can get the maximum value from the plot, for example, the maximum value from the above plot is 114.04. In FIG. 5, the market has a low point of 113.26 and a high of 114.04 and has not traded as low as 113.25 the previous day's settlement.

Referring to FIG. 6, the display shows a positive maximum change bigger than one and less than two revolutions, the maximum value is 115.04. Here, the market has a low point of 113.26 and a high of 115.04 and has not traded as low as 113.25 the previous day's settlement.

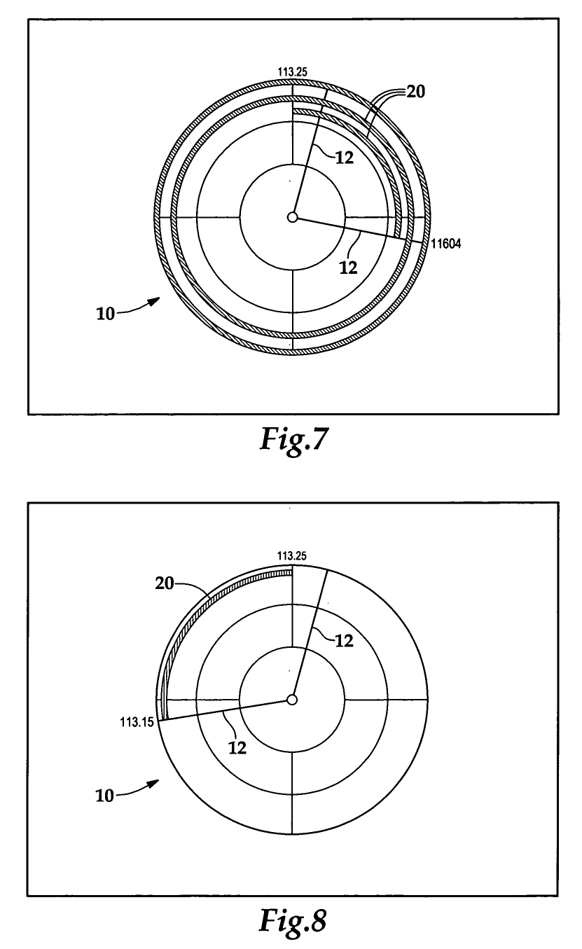

Referring to FIG. 7, the display shows a maximum change bigger than two and less than three revolutions, the maximum value is 116.04. Here, the market has a low point of 113.26 and a high of 116.04 and has not traded as low as 113.25 the previous day's settlement.

Referring to FIG. 8, when a negative maximum change is less than one full revolution or one full point (32/32nds), a red arch 22 appears on the display. Here, the maximum change is 113.15, and the market has a low point of 113.15 and a high of 113.26.

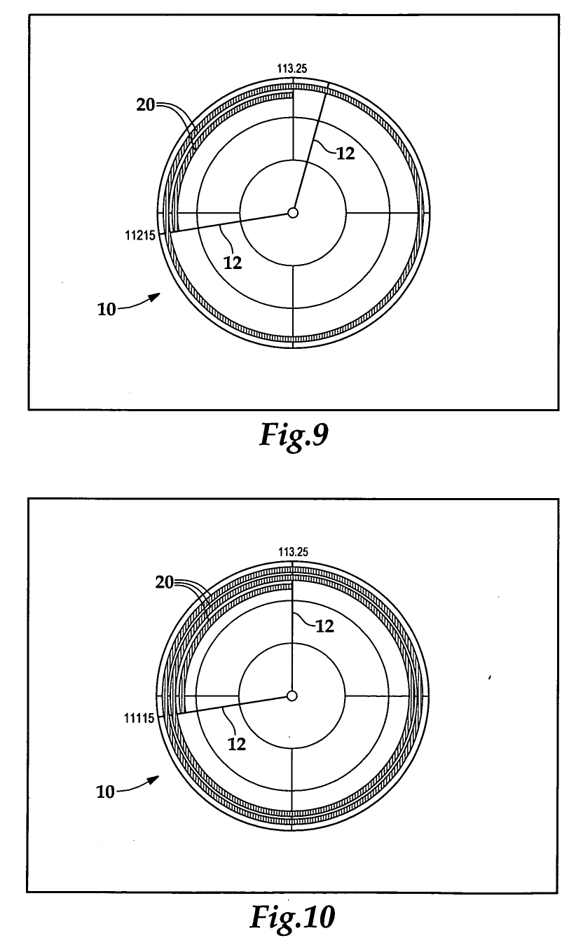

Referring to FIG. 9, the display shows a negative maximum change bigger than one and less than two revolutions, and here, 112.15. The maximum change is 112.15, and the market has a low point of 112.15 and a high of 113.26.

Referring to FIG. 10, the display shows a negative maximum change bigger than two and less than two revolutions, and here, 111.15. The market has a low point of 111.15 and a high of 113.25, the previous day's settlement.

Referring to FIG. 11, the display shows all options (puts, calls) related to the (center) futures clock and also the implied volatility (Imp. Vol.) of each, e.g., using a modified versions of the Black Scholes model. The center clock is the 10 year note futures (TYH) and has a TDC value of 11324. For this illustration it is assumed that this was the previous day's settlement price. To the left of the central clock are four smaller clocks. These are April put options on the underlying futures contract (TYH). The number in the center refers to the strike price (or price option is excercisable at). From top to bottom they are the April 114 put, the April 113 put, the April 112 put, and the April 111 put. On the right side of the center underlying futures contract (TYH) clock are four more smaller clocks, these are call options with their strike prices indicated by the number inside, again from top to bottom they are the April 116, 115, 114, and 113 calls.

The outermost clocks on the left and right sides of the show the implied volatilities (Imp. Vol.) (%) associated with each option. The T.D.C. values on the puts and calls and on the volatilities associated with each represent the previous day's settlement. As the illustration shows, at 10:24 a.m. the futures contract has advanced to 11404, a gain of 12 tics or 12/32ds form the previous day's (TDS) value. The calls by their nature correlate positively with gains in the underlying futures contract. As can be seen, the puts move negatively when the underlying future contract advances. The change in volatility is a function of the price of the underlying futures contract in relation to the price of a particular put or call option. A modified Black Scholes model is used to obtain these values, which is pretty standard in the industry. The invention shows the trader at a glance a deviation from the T.D.C. in a more precise and usable manner than linear charts.

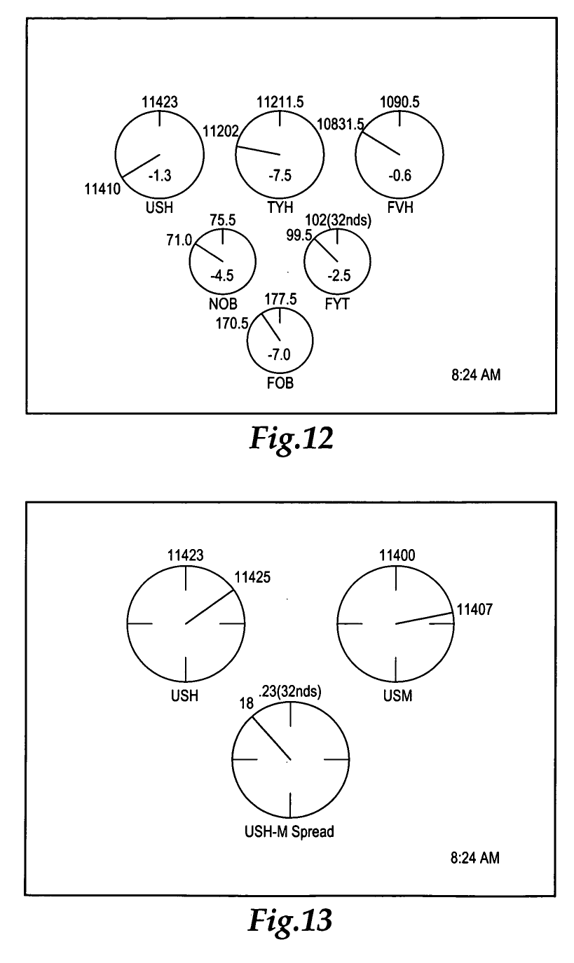

Referring to FIG. 12, the display shows the spread differentials for the different contracts. FIG. 12 shows key relationships between fixed income securities of different maturities, i.e., 5 year, 10 years and 30 year notes and bonds. By employing the TDC concept and the dial features of the invention, the top three clocks show the previous day's settlement for the March futures contract on 30 year bonds (USH), 10 year notes (TYH) and 5 year notes FVH. Below these 3 futures contracts are two clocks showing the price differential between the 10 year note and 30 year bond (NOB) and the difference in price between the 5 year note and the 10 year note (FYT). These clocks are calibrate in 32^{nd's} and ½'s of 32^{nd's}, as the “spreads” are allowed to trade in ½'s of 32^{nd's}, even though, in the case of the 30 year futures contract it only trades in 32^{nd's}. The clock in the bottom shows the price difference between the 5 year note and the 30 year bond (FOB). Each of the clocks show the appropriate TDC values (previous day's settlement). As indicated, at 8:24 a.m. the dials indicate where all the contracts are currently trading in relation to the previous day's settlement. This display (FIG. 12) yields valuable information about what these contracts are trading at both individually, and in relation to each other. Industry jargon refers to the relationships between securities of different maturities as the “yield curve”. Employing the invention, including the TDC concept and the dial with a properly calibrated clock and some smart software shows these relationships much more dynamically than currently available methods.

Referring to FIG. 13, the display shows the spread differentials for the same contracts. Futures contracts on the same commodity, in this case U.S. treasury bonds, trade on a quarterly calendar cycle. The clock on the left (USH) is the March contract, the clock on the right (USM) is the June contract. There are a number of supply and demand factors that influence which cash bonds are deliverable against future contracts of a different delivery month. The clock on the bottom shows the spread (USH-M) between these two contracts. Traders watch these relationships very closely. The invention, using the TDC concept with a properly calibrated spread clock and appropriate software causes this display dial to show where these relationships are at a glance.

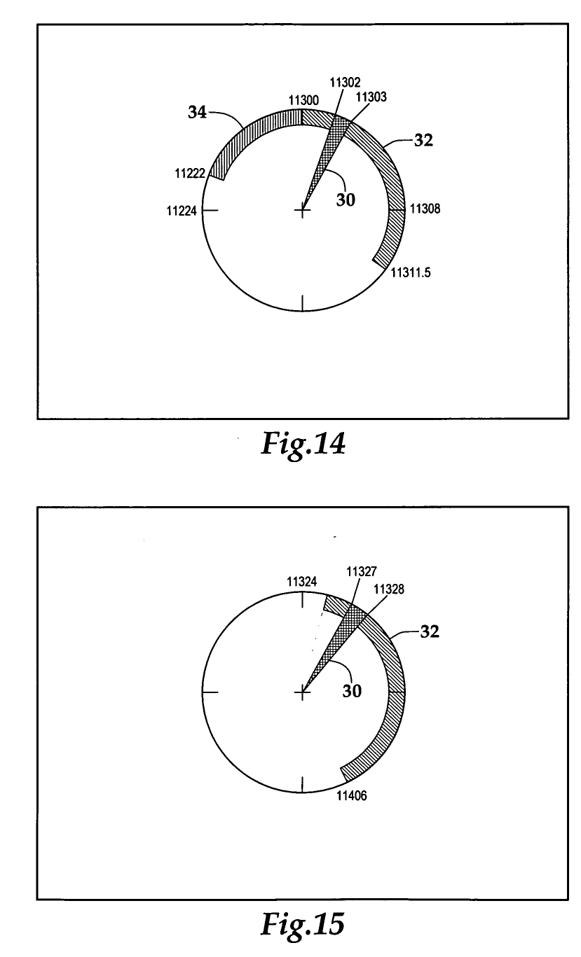

Referring to FIG. 14, another, more detailed display (clock) is shown. This display shows a segment 30 (which will be yellow in the actual display) which denotes an “opening range” within a positive range 32 (in green) of 113.02 to 113.03. A negative range 34 between 113.00 and 112.22 is shown in red. Also shown is 11300 (the previous days settlement) and a positive range to 11311.5.

Referring to FIG. 15, in similar fashion to FIG. 14, this display shows that the market has a low point of 113.26 and a high of 114.06 and has not traded as low as 113.24, the previous day's settlement. This display also shows an “opening range” of 113.27 to 113.28.

While the foregoing written description of the invention enables one of ordinary skill to make and use what is considered presently to be the best mode thereof, those of ordinary skill will understand and appreciate the existence of variations, combinations, and equivalents of the specific exemplary embodiment and method herein. The invention should therefore not be limited by the above described embodiment and method, but by all embodiments and methods within the scope and spirit of the invention as claimed.

What is claimed is:

1. A method for providing a display of securities information, said method comprising the steps of:
entering securities trading information, said securities trading information comprising a desired reference point, and at least one price for at least one security in a current trading period, and
displaying said securities-trading information in the form of at least one circular clock-like display.

2. A method as in claim 1, wherein said desired reference point comprises a closing price for at least one security from a previous trading period.

3. A method as in claim 1, wherein said securities information is displayed through an electronic medium such as a computer display screen.

4. A method as in claim 1, wherein said entering comprises manually inputting information using a keyboard.

5. A method as in claim 1, wherein said entering comprises receiving said information from a live feed.

6. A method as in claim 1, wherein said securities trading information further comprises: at least one range of prices for said at least one security during said current trading period.

7. A method as in claim 1, wherein said display comprises at least one circle having a circumference representing one full point change in the price of a security, a top center point on said circumference representing said desired reference point, and at least one radial line representing at least one price for said at least one security in the current trading period, and a plurality of evenly spaced marks lines around said circumference corresponding to predetermined increments of one point in a price of said security.

8. A method as in claim 7, wherein said display comprises a second radial line representing a second price for said at least one security in the current trading period, with an area between said first radial line and said second radial line representing least one price range for said at least one security in the current trading period.

9. A method as in claim 7, wherein said display comprises at least one circumferential line extending to from top center point to said at least one radial line, and representing a price change between the first price and said at least one price for said at least one security in the current trading period.

10. A method as in claim 7, wherein said circumferential line appears in one color for a positive price change and in a second color for a negative price change.

11. A method as in claim 7, wherein at least one radial line appears in one color when said at least one price is greater than said first price and in a second color when said at least one price is less than said first price.

12. A method as in claim 5, wherein said at least one circumferential line comprises a circumferential line extending circumferentially one full revolution around said circle for each full point in said price change between the first price and said at least one price for said at least one security in the current trading period.

13. A method as in claim 7, wherein said display comprises a plurality of circles, each having a circumference representing one full point change in the price of a security, a top center point on said circumference representing a first price, such as a settlement price of said one security from a previous trading period, and at least one radial line representing at least one price for said at least one security in the current trading period, and a plurality of evenly spaced marks lines around said circumference corresponding to predetermined increments of one point in price of said security.

14. A method as in claim 13, wherein a first one of said circles represents a given security and others of said circles represent derivatives of said given security, such as options.

15. A method as in claim 13, wherein still others of said circles represent implied volatilities of said derivatives.

16. A method as in claim 12, wherein a first plurality of said circles represent given securities and others of said circles represent spread differentials for said given securities.

17. A method as in claim 7, wherein said display comprises a two further radial lines representing limits of a second price range for said at least one security in the current trading period, with an area between said two further radial lines representing said second price range for said at least one security in the current trading period.

18. A method as in claim 8, wherein said area appears in one color for a positive price change and in a second color for a negative price change.

19. A method as in claim 17, wherein said area appears in one color for a positive price change and in a second color for a negative price change.

20. A method as in claim 18, wherein said area appears in third color to represent an opening price range.

21. A method as in claim 7, wherein said radial line appears in one color for a positive price change and in a second color for a negative price change.
